(19) United States
(12) Patent Application Publication
(10) Pub. No.: US 2019/0335675 A1
(43) Pub. Date: Nov. 7, 2019

(54) GROW LIGHTS FOR HORTICULTURE

(71) Applicants: Phuc Ngo, San Jose, CA (US); Kris Le, San Jose, CA (US); Vidyadhar Handragal, San Jose, CA (US)

(72) Inventors: Phuc Ngo, San Jose, CA (US); Kris Le, San Jose, CA (US); Vidyadhar Handragal, San Jose, CA (US)

(21) Appl. No.: 15/973,496

(22) Filed: May 7, 2018

(51) Int. Cl. A01G 7/04; A01G 9/02; F21V 21/30; F21V 23/00; F21V 21/22

(52) U.S. Cl. CPC A01G 7/045; A01G 9/023; A01G 9/027; F21Y 2115/10; F21V 23/007; F21V 21/22; F21V 21/30

(57) ABSTRACT

A growth lighting system includes a central module having hingeable arms to secure the central module to a ceiling; left and right panels extending from the central module, wherein each panel is positioned at a selectable inclination and angle to provide placement of the panels at predetermined position to the plant satisfying predetermined plant light requirements; and a plurality of light emitting diodes positioned on the central module and the left and right panels to provide lighting to the plants.

### BACKGROUND

The present invention relates to plant lighting.

A grow light or plant light is normally an artificial light source, typically an electric light, designed to stimulate plant growth by emitting a light appropriate for photosynthesis. These lights are used in applications where there is either no naturally occurring light, or where supplemental light is required. Grow lights either attempt to provide a light spectrum similar to that of sunlight or provide a specific spectrum that is more suited to the requirements of the plants being cultivated. The intent is to mimic outdoor conditions by varying color, temperatures and spectral outputs from the grow lights, as well as varying the lumen output (intensity) of the lamps. Depending on the type of plant being cultivated, the stage of cultivation (e.g. the germination/vegetative phase or the flowering/fruiting phase), and the photoperiod required by the plants, specific ranges of spectrum, luminous efficacy and color temperature are desirable for use with specific plants and for the desired time periods.

Early research concerning the effects of different light spectra on plants demonstrates that red and blue lights offer the best support for photosynthesis, which is the process utilized by plants to transform light into the energy needed for growth and flowering. Further investigation pinpointed more specific effects of different light wavelengths on plants grown indoors. Typical research findings of various studies provide the basis for various light recipes.

In providing lights for plants, the current lighting fixtures that incorporate lighting are limited due to:

1. varying fixtures dimensions and fixture types are required to achieve the best results and rarely a combination of the above parameters can be fulfilled.

2. cumbersome arrays of light sources

3. significant downtime in case of faults or repairs

### SUMMARY

In one aspect, a growth lighting system includes a central module having hingeable arms to secure the central module to a ceiling; left and right panels extending from the central module, wherein each panel is positioned at a selectable inclination and angle to provide placement of the panels at predetermined position to the plant satisfying predetermined plant light requirements; and a plurality of light emitting diodes positioned on the central module and the left and right panels to provide lighting to the plants.

In another aspect, a method for growing plants include providing a central module having hingeable arms to secure the central module to a ceiling; left and right panels extending from the central module, wherein each panel is positioned at a selectable inclination and angle to provide placement of the panels at predetermined position to the plant satisfying predetermined plant light requirements; and a plurality of light emitting diodes positioned on the central module and the left and right panels to provide lighting to the plants; and angling the hingeable arms and panels to provide a predetermine light to the plant.

Advantages of the system may include one or more of the following. The system provides highly tailored placement and angling of the light sources such as LED lights to optimize plant growth. Acquiring LED grow lights is an investment that is bound to pay off over time due to the lights' low energy consumption, low heat emission and light spectra optimized for efficient plant growth. However, the investment may prove to be wasteful if the crucial step of light planning is executed improperly. The system helps the grower in achieving the largest possible optimal light intensity area with lowest possible number of luminaires. In addition to proper positioning of the light sources, the system provides the proper light wavelength for growing plants and can use predetermined pulses of radiant energy. The system would provide these pulses at a rate and duration to achieve a higher ratio of energy utilization for photosynthesis than energy reradiated by the plants or utilized for other plant processes as compared to the same utilization ratio of plants grown under continuous radiant energy. Such pulsed lighting provides fast plant growth while the power requirements for growing plants with artificial lighting on a large scale commercial basis is reduced significantly so as to become economically feasible.

Many of the attendant advantages of the present invention will become more readily apparent upon consideration of the following detailed specification in connection with the accompanying drawings.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows an exemplary Isometric View of a Linear Expandable Grow Light Fixture;

FIG.1B shows an exemplary Plan View of the Expandable Grow Light Fixture of FIG. 1A;

FIG. 1C shows an exemplary plant illumination using the Linear Expandable Grow Light Fixture of FIG. 1A;

FIG. 1D shows an exemplary LED arrangement for a panel of the Linear Expandable Grow Light Fixture;

FIG.2A shows an exemplary Isometric View of an Extendable Roller or Radial Grow Light Fixture;

FIG. 2B shows an exemplary plant illumination using the Extendable Roller or Radial Grow Light Fixture of FIG. 2A;

FIG. 3A shows an exemplary Telescopic Grow Light Fixture;

FIG. 3B shows an exemplary light illumination of the Telescopic Grow Light Fixture in a closed condition.

FIG. 3C shows an exemplary light illumination of the Telescopic Grow Light Fixture in an open condition.

FIG. 4 shows an exemplary multitier growth space that is stacked; and

FIG. 5 shows an exemplary flat or linear growth space.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Additionally, the term “horticultural growth” is known in the art and may relate herein to any plant, crop, bush, tree, including for example vegetation that bears or is a fruit, a vegetable, a mushroom, a berry, a nut, a flower, a tree, a shrub, or a turf. Horticultural growth herein especially relates to indoor horticultural growths, such as especially any plant, crop, bush, tree, grown for human or animal consumption or other human use, such as indoor or outdoor decoration. Also, a person skilled in the art should notice this description may contain other terminology to convey position, orientation, and direction without departing from the principles of the present invention.

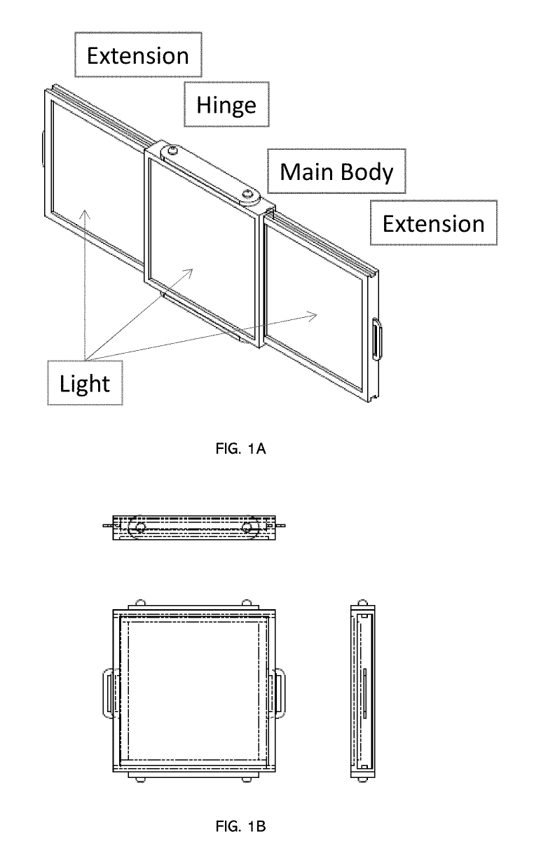

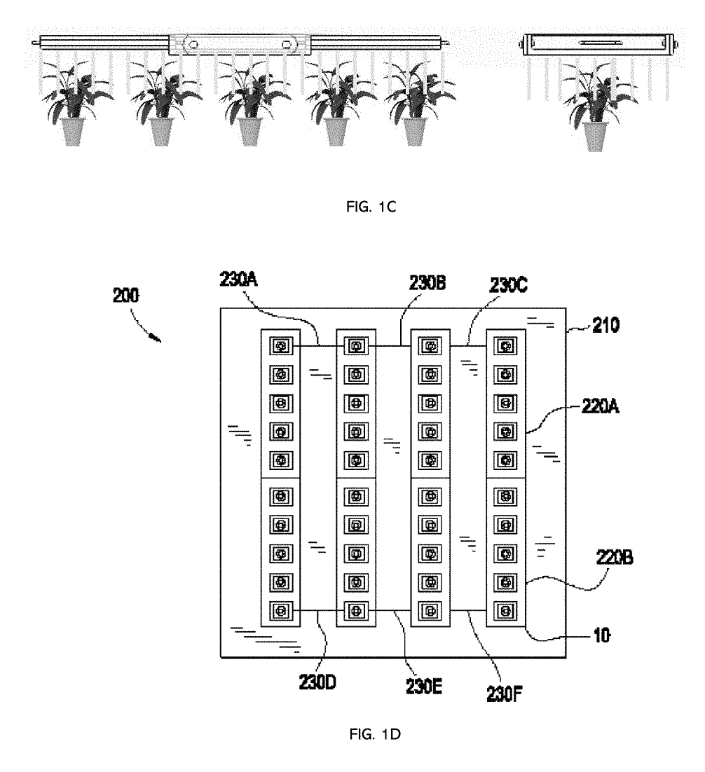

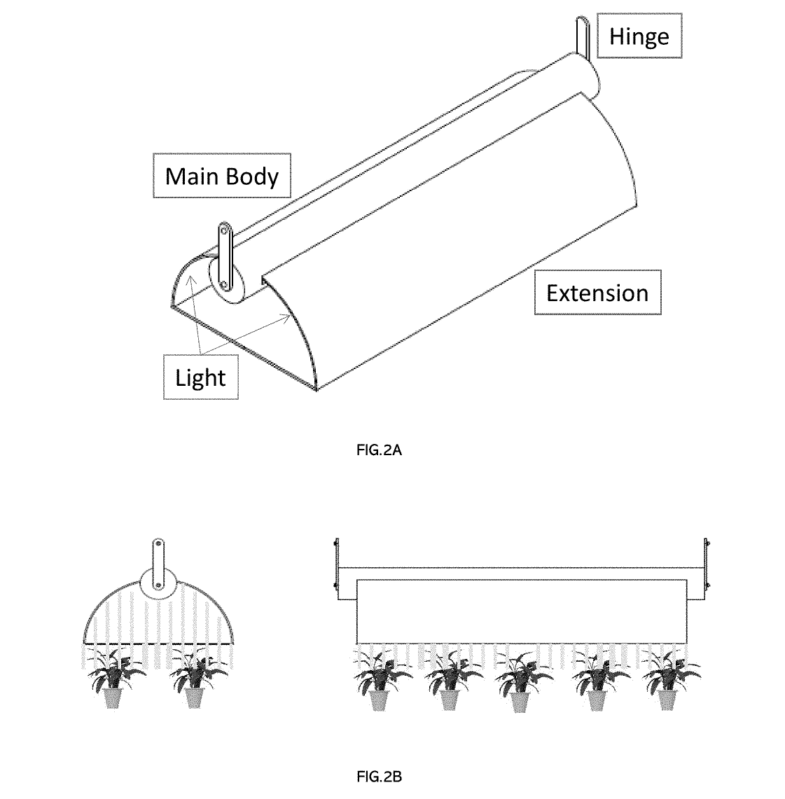

FIG. 1A shows an exemplary Isometric View of a Linear Expandable Grow Light Fixture 100. Setting up grow lights is an expensive investment that is bound to pay off over time due to the lights' low energy consumption, low heat emission and light spectra optimized for efficient plant growth. However, the investment may prove to be wasteful if the crucial step of light planning is executed improperly. It is all about achieving the largest possible optimal light intensity area with lowest possible number of luminaires. It is in this regard, the instant addresses the limitations in a cost-effective manner.

Turning now to FIG. 1A, the system provides a luminaire design or a lighting unit consisting of one or more electric lamps with provision for all the necessary parts and wiring. The system provides a means of maximizing the effect of grow lighting without the need of expensive lighting fixtures. The fixture 100 is secured to a ceiling 102 using a plurality of hinged attachment arms 104. The arms 104 are hingeably and rotatably coupled to the ceiling 102 and a base light panel 106. The base light panel 106 in turn is extendable to provide two additional light panels 108 and 110. In one embodiment, each of panels 106-110 has a width of about two feet, and the fixture 100 is expandable to six feet in length when the two panels 108-110 are fully extended. The hingeable arms 104 are adjustable to position the central module at a predetermined position in 3D space for lighting the plants. Further, each of the left and right panels 108-110 is adjustable to position the LEDs on the panels at a predetermined position in 3D space for lighting the plants. For example, the hingeable arms and panels support linear and radial movement of the lights to impact the exposure to the plants to a desired light exposure. In another embodiment, the arms and hingeable panels support linear and radial movement of the lights to impact the exposure to the plants to a desired light exposure.

The fixture 100 has a housing 111 that may include a protective door for protecting the power supply unit from the environmental conditions. The door may be made of a suitable metal such as aluminum and is connected at a set of hinges to the fixture housing 111 via suitable fasteners, such as rivets or screws for example.

A range of light bulb types can be used as grow lights, such as incandescent, fluorescent lights, high-intensity discharge lamps (HID), and light-emitting diodes (LED). For commercial plant growth, the most widely used lights are HIDs and fluorescent lights. Indoor growers typically use high-pressure sodium (HPS) and metal halide (MH) HID lights, but fluorescents and LEDs are replacing metal halides due to their efficiency and economy. LED grow lights provide a full spectrum of light designed to mimic natural light, providing plants a balanced spectrum of red, blue and green. While prevailing bulbs types such as incandescent, fluorescent lights, high-intensity discharge lamps (HID) and light emitting diodes (LEDs) can be used, preferably the lighting sources are LEDs since they provide relatively higher efficiency, enhanced life and with the diodes packaged in smaller sizes.

In the LED embodiment, the LED fixture housing 111 contains a power supply unit (not shown) and a plurality of LEDs mounted on a printed circuit board or module. Specific details of the LED module are not shown in FIG. 1A for purposes of clarity. The power supply unit may be secured to an interior surface of the fixture housing with suitable fasteners such as screws, so as to be easily removable. The power supply unit may be switched out and replaced with any other power supply unit, of any size, so long as it fits within the footprint of the space available within the fixture housing. The power supplies may be constant current drivers which supply constant but adjustable current with variable voltage, depending on the number of LEDs. For example, a suitable power supply may be a switch mode, switching LP 1090 series power supply manufactured by MAGTECH, such as the MAGTECH LP 1090-XXYZ-E series switchmode LED driver, for example. The driver has an adjustable voltage range and the type of driver depends on the voltage drop of each of the LEDs in series in the LED matrix.

Each panel 106-110 has air vents 112 to provide air cooling of the LEDs. The interior of the fixture 100 has heat spreading components. For example, a plurality of fins or heat spreading T-bars may be provided with channel spacings there between to facilitate thermal dissipation through the vents 112. In one example, these fins may be formed as part of the panels 106-110. The panel housing may be made of a suitable material providing a heat sinking or heat spreading capability, such as aluminum, ceramic and/or other materials.

FIG. 1B shows a Plan View of one embodiment of the Expandable Grow Light Fixture with LEDs, while FIG. 1C shows a bottom view of one panel 106-110. The LED lighting package 200 may be used in the fixture 100 and includes a backing 210 of thermally conductive material such as aluminum due to its abundance and inexpensive cost, although other thermally conductive materials such as copper, ceramics, plastics, and the like may be utilized. In this example, the LED lighting package 200 includes four columns of LEDs. Each column in this example may include at least two printed circuit boards (PCB) such as PCB 220A and 220B. On each PCB, at least five LEDs, such as LED are mounted and electrically connected in series with each other, it being understood that more or less LEDs could be serially mounted. In this example, the total number of LEDs in LED lighting package 200 is forty.

Each PCB 220A/B includes a positive voltage terminal and a negative voltage terminal (not shown). The negative voltage terminal of PCB 220A is electrically connected to the positive voltage terminal of PCB 220B so that the ten LEDs defining a column are electrically connected in serial. Although two PCBs are shown to construct one column of LEDs, a single PCB may also be utilized for a particular column of LEDs. Each column of ten LEDs is electrically connected in parallel to its adjacent column over wires 230A-D and are equally spaced at a distance d measured in the horizontal direction from the center of adjacent LEDs. For example, the distance, d, in FIG. 8 may be approximately 2.4 inches, although other dimensions are possible. In the vertical direction, the LEDs are equally spaced at a distance, v, where v may be approximately 1 inch, although other dimensions are possible. The backing 210 may be anodized white aluminum to reflect the light emitted from the LEDs.

It is understood that any number of LEDs may be provided in an array of LEDs for example (i.e., serial columns in parallel). The LEDs may be mounted on a printed circuit board that is mounted onto a copper backing (plate or sheet). The backing may be used to help spread heat generated by the LEDs and to compensate for thermal resistance between components of the LED module. It is understood that materials with good thermal conductivity other than copper may also be used such as silver, alloys of copper or silver or other metal materials having high thermal conduction properties. The shape of the LED array is irrelevant; it can be trapezoidal, oval, square, rectangular, circular, etc. so long as it fits within the footprint of the fixture housing 111. Additionally, the type of power supply used does not matter, and a suitable variable power supply such as the LP 1090 may be automatically variable between 90 and 240 volts depending on the particular application of the modular LED lighting fixture 100.

As for the individual LEDs of the fixture 100, the LEDs may be slanted at different angles, at the same angles, in groups of angles which differ from group to group, etc. For example, in an area lighting application, the shape of the light output may be varied by the angle of the LEDs from normal, the shape or orientation of the LEDs may be done so as to provide a single modular LED lighting fixture 100 which may be altered from any of Types I, II, III, IV or V roadway classifications by swapping out differently configured LED modules. Thus, the LEDs can be provided on one, some, or all strips or groups of strips and can be mounted at different angles to the planar, bottom surface of the fixture housing 110. Additionally, a given strip may be straight or curved, and may be angled with respect to one or more dimensions. In another example, each LED, groups or strips of LEDs constituting the LED module may include the same or different secondary optics and/or reflectors. In other examples, the groups or strips may be mounted at varying ranges of angles, and different optical elements or no optical elements may be used with the groups or strips of LEDs mounted at differing ranges of angles.

The LEDs may be configured to emit any desired color of light. The LEDs may be blue LEDs, green LEDs, red LEDs, different color temperature white LEDs such as warm white or cool or soft white LEDs, and/or varying combinations of one or more of blue, green, red and white LEDs 135. In an example, white light is typically used for area lighting such as street lights. White LEDs may include a blue LED chip phosphor for wavelength conversion. One, some or all LEDs may be fitted with a secondary optic that shapes the light output in a desired shape, such as circle, ellipse, trapezoid or other pattern. Further, the LEDs are protected by a hinge able window which may be made suitable glass or opaque material rimmed by an outer metal frame and hinged at to the fixture housing.

According to the inverse-square law, the intensity of light radiating from a point source (in this case a light bulb) that reaches a surface is inversely proportional to the square of the surface's distance from the source (if an object is twice as far away, it receives only a quarter the light) which is a serious hurdle for indoor or constrained space growers, and many techniques are employed to use light as efficiently as possible. Reflectors are often used in the lights to maximize light efficiency. Plants or lights are moved as close together as possible so that they receive equal lighting and that all light coming from the lights falls on the plants rather than on the surrounding area.

During deployment of the fixture 100, the following aspects of light affects both plant growth (photosynthesis) and plant development (morphology):

a) light intensity

b) total light over time

c) light at which moment of the day

d) light/dark period per day

e) light quality (spectrum)

f) light direction

g) light distribution over the plants

The light planning setup is done to best to feed plants with light to ensure efficient plant growth, and the process involves the following:
Phase 1: Determining plant requirements (number of hours the plant is exposed to light, how many photons are ‘fed’ to the plants (in μmol/m2/s), combinations of light spectrum wavelengths for each growth phase)
Phase 2: The choice of lighting luminaires (how many luminaires should be used, what kind of luminaires and how they should be positioned)
Phase 3: Includes multiple considerations such as the following:
To meet the μmol/m2/s requirements for each growth phase with the lowest possible fixture number thereby reducing costs of the lighting system acquisition.
To achieve the maximum light uniformity at the target illuminated area. This means creating the most efficient lighting layout with which the biggest number of plants will be covered with the required light intensity levels.
To reduce light loss by optimizing the spacing and height of the fixtures. This means planning the lighting configuration so that the biggest part of illumination will be directed to the crops and in a way that the optimal light intensity area is as large as it can be. This decision helps to get the most efficient use of lighting from each used Watt of energy.

Embodiments of the present invention may provide both increased efficiency in supplying plants with energy while providing attractive (color temperature) and realistic (color rendering) appearance to humans. The figures and accompanying description below shows overlays of the new grow light spectrum with the plant action spectrum and the human photopic response according to two example embodiments of the invention. Neither of the example embodiments nor specific features of their implementations should be considered limiting to the scope of the invention. The following parameters are relevant to photosynthetic efficiency in grow light technology:
Photosynthetically Activated Radiation (PAR)—radiation between 400 and 700 nm (how much light energy is available to plants)
Photosynthetic Photon Flux (PPF)—number of photons per second onto one square meter
Yield Photon Flux (YPF)—weighted measure of photons per second (how effectively the PPF is used by plants); Note: Because red light (or red photons) is used by a grow light more effectively to induce photosynthetic reaction, YPF PAR gives more weight to red photons based on the plant sensitivity curve.

In one embodiment, the lighting system can be computer controlled with a microcontroller and wireless communication with a server. The microcontroller can control the LED driver and a pulse width modulation (PWM) protocol may be employed to address potential overheating issues, and to optimize efficiency. By using PWM per individual color or colors of LEDs, the photon flux may be tuned and optimized to prevent oversaturation and overheating. In one embodiment, the system may be programmed to generate spectra for a specific type of flora. Each type of plant may have different saturation levels. Additionally, plant saturation levels may vary depending on 1) stage of growth, 2) nutrient availability, 3) ambient light levels (time of day), and other factors. The illumination and grow light system of the present invention may be programmed to optimize photon color and flux based on the unique characteristics and limitations of the subject plant.

By pulsing the LEDs in a synchronous or quasi-synchronous manner in relation to a plant's ability to absorb photon energy and use it for photosynthesis (or other plant metabolic activity), not only may heat be minimized but also energy efficiency can greatly be increased. More specifically, pulsing may ensure that photons are not impinging on plant tissue (or impinging less) when the plant cannot use the photon energy metabolically. Applied in the method described above, PWM may achieve not only optimum growth characteristics but also may result in a dramatic reduction in energy use and cost by the users of systems and methods disclosed herein. By coordinating pulses such that the light is off when the leaf or photosynthetic system is saturated, energy may be conserved, efficiency increased, and heating minimized. Other means of pulsing the light or otherwise delivering light or specific wavelengths of light and intensities at specific time intervals to achieve a specific or desired level of photon dosing or PAR dosing may also be employed as will be evident to those skilled in the art.

In another embodiment of implementing the method described above, monitoring the saturation level of a subject plant may be accomplished using sensors. Plants may have fluorescent properties, and the sensing or measuring of the fluorescent output can be used to coordinate the spectrum, intensity, and timing of the grow light. For example, and without limitation, a wide variety of species of algae is known to fluoresce upon exposure to visible light. In some cases, the fluorescence spectrum emitted may indicate the status of the plant, such as metabolic activity, health, saturation of light, and time from dark adaptation. By sensing or measuring the fluorescence or attributes thereof (e.g., with a fluorometer, spectrometer, infrared sensor, or other device), information about the state of the flora may be obtained. That information can be used (e.g., programmed into a controller) to drive the emissions of a grow light such that its output is optimized for the given condition of the flora and environment. For example, and without limitation, it is known that in some cases light saturation of the photosynthetic system (PS) may cause a change in the fluorescence of the organism. Thus, in this example, saturation levels of light may be identified or predicted by measuring the fluorescence spectrum in real-time. This information may then be used to drive the grow lamp (or elements thereof), for example, using PWM or PAM/PIM such that over-saturation may be prevented, energy may be conserved, and plant growth may be optimized.

In yet another embodiment of implementing the method described above, pulsing the light source on or off may be accomplished by manually or automatically adjusting individual light sources and/or the entire lighting unit in order to deliver light and/or light intensity within a given solid angle or directed to a certain area of plants. Example embodiments are illustrated in FIGS. 18a-d, the various arrangements of which may allow for controlling the intensity of light and spectrum falling of a given set or plants or plant species. Alternatively or additionally, the adjustment of the combined light emitted from a lighting unit may be managed by a controller which is connected to a sensor (e.g., ambient light sensor, plant growth sensor, CO2 sensor, timer, etc.). Although the examples shown are for a linear fixture, other shapes or combination of shapes that are either fixed or adjustable (via hinges, connectors, etc.) may be used to obtain the desired distribution and are within the scope of the invention.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. As described, some or all of the steps of each method may be implemented in the form of computer executable software instructions. Furthermore, the instructions may be located on a server that is accessible to many different clients, may be located on a single computer that is available to a user, or may be located at different locations. Therefore, the claims should be interpreted in a broad manner, consistent with the present disclosure. While various embodiments have been described for purposes of this disclosure, numerous changes and modifications will be apparent to those of ordinary skill in the art. Such changes and modifications are encompassed within the spirit of this invention as defined by the claims.

FIG.2A shows a Roller Configuration—Extended condition, while FIG. 2B shows the Roller Configuration—Plant Illumination. Turning to FIG.2A, an exemplary isometric view of an exemplary Extendable Radial Grow Light Fixture 300 is detailed. In this embodiment, arms 304 are hingeably and rotatably coupled to the ceiling 102 and a base light column 306. The base light column 306 in turn is rotatably connected two additional light panels 308 and 310. In one embodiment, each of panels 306-310 has a width of about two feet, and the fixture 300 is expandable to about four feet in length when the two panels 308-310 are fully extended.

The column 306 has a housing 311 that may include a protective door for protecting the power supply unit from the environmental conditions. The door may be made of a suitable metal such as aluminum and is connected at a set of hinges to the fixture housing 111 via suitable fasteners, such as rivets or screws for example.

A range of light bulb types can be used as grow lights, such as incandescent, fluorescent lights, high-intensity discharge lamps (HID), and light-emitting diodes (LED). For commercial plant growth, the most widely used lights are HIDs and fluorescent lights. Indoor growers typically use high-pressure sodium (HPS) and metal halide (MH) HID lights, but fluorescents and LEDs are replacing metal halides due to their efficiency and economy. LED grow lights provide a full spectrum of light designed to mimic natural light, providing plants a balanced spectrum of red, blue and green. While prevailing bulbs types such as incandescent, fluorescent lights, high-intensity discharge lamps (HID) and light emitting diodes (LEDs) can be used, preferably the lighting sources are LEDs since they provide relatively higher efficiency, enhanced life and with the diodes packaged in smaller sizes. In the LED embodiment, the LED fixture housing 311 contains a power supply unit (not shown) and a plurality of LEDs mounted on a printed circuit board or module. Specific details of the LED module are not shown in FIG. 2 for purposes of clarity. The LED angle and spacing are flexibly adjustable as discussed above to provide the exact lighting needed.

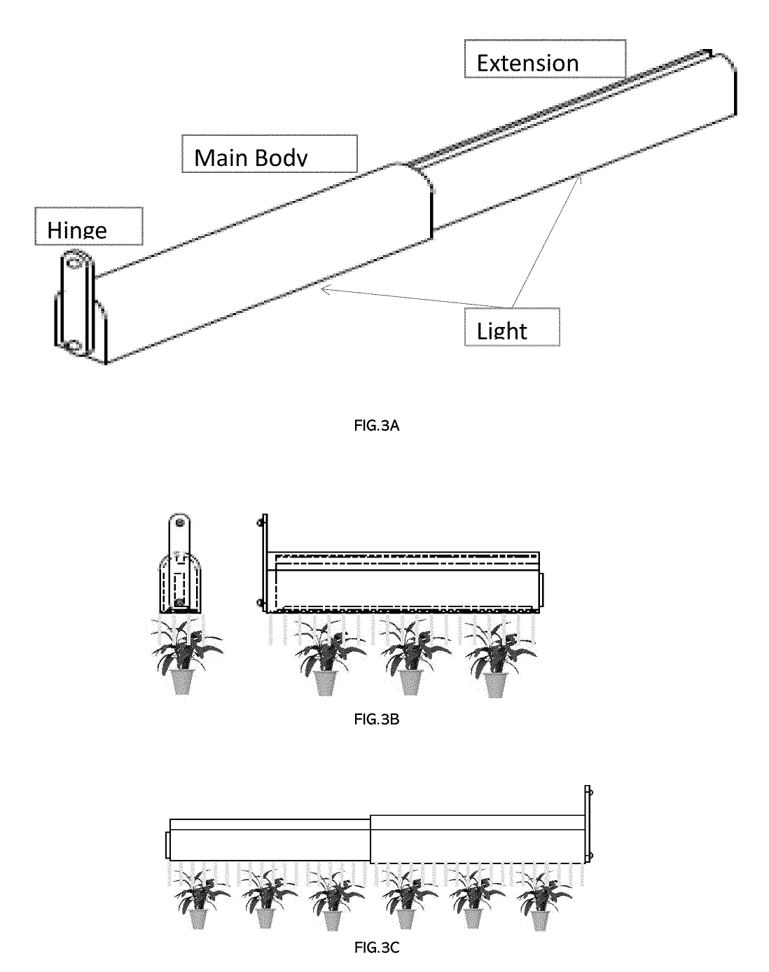

FIG. 3A shows an exemplary Telescopic Grow Light Fixture. In this embodiment, the light has a main body with a telescopic extension with light under both the body and the extension. FIG. 3B shows an exemplary light illumination of the Telescopic Grow Light Fixture in a closed condition while FIG. 3C shows an exemplary light illumination of the Telescopic Grow Light Fixture in an open condition.

The above systems described above provide the following advantages:

i. Modular lighting unit or fixture designed to fit into narrow or confined spaces.

ii. Once fitted onto the mounting points, the fixture permits linear & radial movement of the light units to impact the exposure to the plants thereby maximizing the desired light exposure.

iii. Reusability of the fixture enabling easy adaptability to mount new light sources, cleaning, quickly fix faulty elements of the fixture.

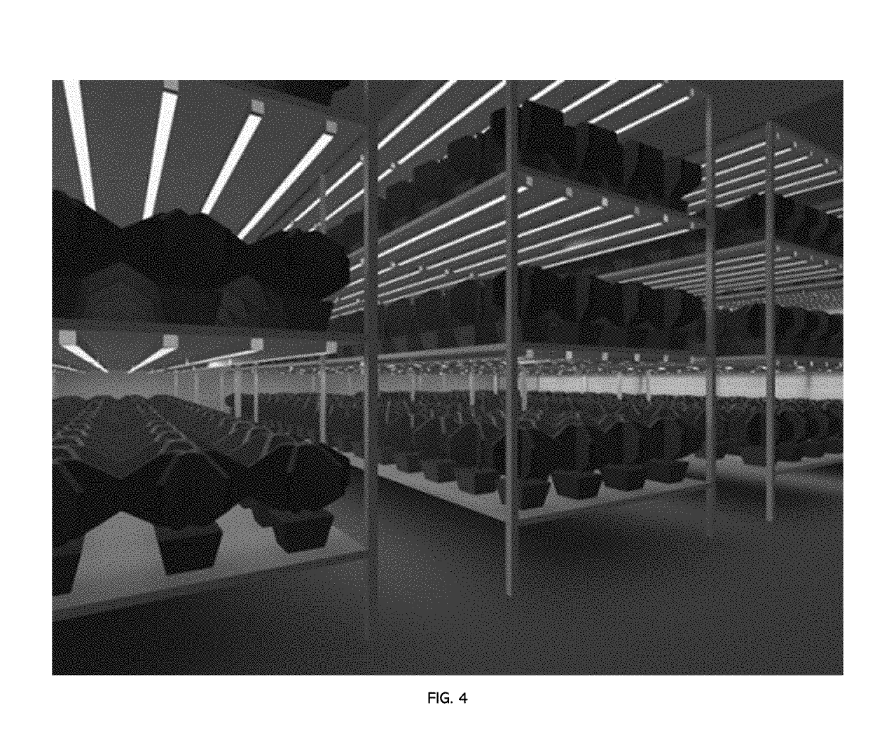

FIG. 3 shows an exemplary multitier growth space that is stacked and FIG. 4 shows an exemplary flat or linear growth space. These figures show how the light fixtures are used in a typical constrained grow space. The extendable panels allow flexibility in with the fixed arrangements of the lighting fixtures.

Additionally, with regards to the surrounding structures required to place the plants or pots containing the plants, the system of FIGS. 1-3 can accommodate the below factors or considerations which play an important role in plant growth:

h) installation height of the fixtures

i) placing of the tables

j) gutters or pots in the space

k) the reflection factor of all objects and materials in the space

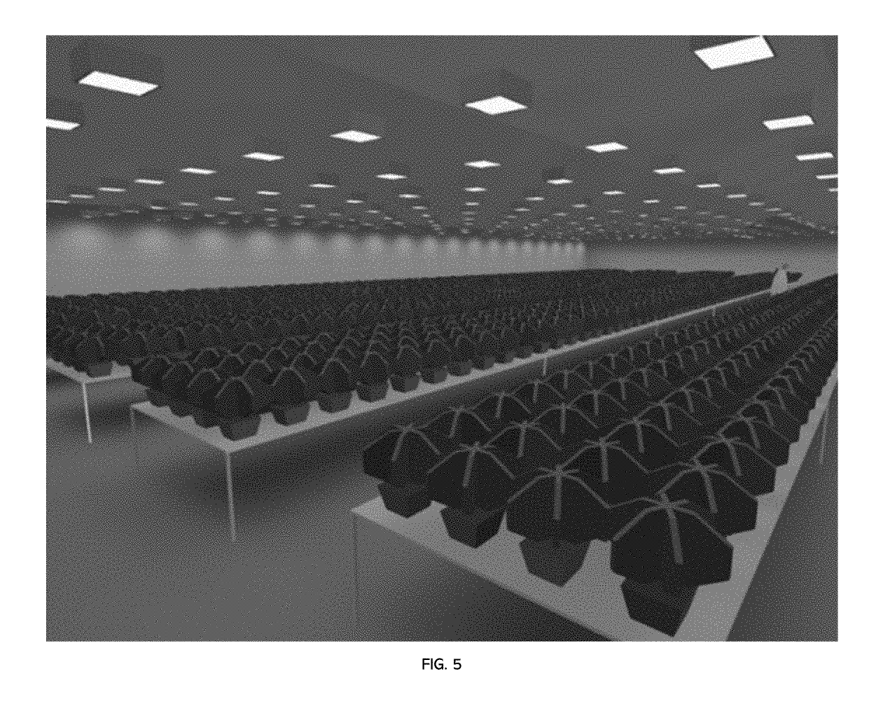

Reaching the above goals is a process of trial and error and in practice means tweaking the parameters multiple times. The system provides the greatest possible optimal light intensity area with a minimal number of luminaires or array arrangements. The instant grow lights can be used on an industrial level, nevertheless they can also be used in households or in constrained space environment as in gardens at home or smaller warehouses. FIG. 4 shows an exemplary multitier growth space that is stacked; and FIG. 5 shows an exemplary flat or linear growth space.

Embodiments of the present invention are described herein in the context of a system of computers, servers, and software. Those of ordinary skill in the art will realize that the following embodiments of the present invention are only illustrative and are not intended to be limiting in any way. Other embodiments of the present invention will readily suggest themselves to such skilled persons having the benefit of this disclosure.

The example embodiments of the present invention being thus described, it will be obvious that the same may be varied in many ways. For example, the shape of the panels can be curvilinear or any suitable shapes. Further, the arrangement of the LED can be columnar, circular, or any desired pattern.

In accordance with embodiments of the present invention, the components, process steps, and/or data structures may be implemented using various types of operating systems, computing platforms, computer programs, and/or general purpose machines. In addition, after having the benefit of this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The computer program, according to an embodiment of the present invention, is a computerized system that requires the performance of one or more steps to be performed on or in association with a computerized device, such as, but not limited to, a server, a computer (i.e., desktop computer, laptop computer, netbook, or any machine having a processor), a dumb terminal that provides an interface with a computer or server, a personal digital assistant, mobile communications device, such as an cell phone, smart phone, or other similar device that provides computer or quasi-computer functionality, a mobile reader, such as an electronic document viewer, which provides reader functionality that may be enabled, through either internal components or connecting to an external computer, server, or global communications network (such as the Internet), to take direction from or engage in processes which are then delivered to the mobile reader. It should be readily apparent to those of skill in the art, after reviewing the materials disclosed herein, that other types of devices, individually or in conjunction with an overarching architecture, associated with an internal or external system, may be utilized to provide the “computerized” environment necessary for the at least one process step to be carried out in a machine/system/digital environment. It should be noted that the method aspects of the present invention are preferably computer-implemented methods and, more particularly, at least one step is preferably carried out using a computerized device.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

Such variations are not to be regarded as departure from the spirit and scope of the example embodiments of the present invention, and all such modifications as would be obvious to one skilled in the art are intended to be included within the scope of the following claims.

What is claimed is:

1. A light system for a plant, comprising:
a central module having hingeable arms to secure the central module to a ceiling;
left and right panels extending from the central module, wherein each panel is positioned at a selectable inclination and angle to provide placement of the panels at predetermined position to the plant satisfying predetermined plant light requirements; and
a plurality of light emitting diodes positioned on the central module and the left and right panels to provide lighting to the plants.

2. The system of claim 1, wherein the hingeable arms and panels support linear and radial movement of the lights to impact the exposure to the plants to a desired light exposure.

3. The system of claim 1, wherein the arms and hingeable panels support linear and radial movement of the lights to impact the exposure to the plants to a desired light exposure.

4. The system of claim 1, wherein the module and left and right panels are planar.

5. The system of claim 1, wherein the module is cylindrical and left and right panels are curved.

6. The system of claim 1, comprising a housing for the central module, wherein the housing includes a power supply for the lights.

7. The system of claim 1, wherein the hingeable arms are adjustable to position the central module at a predetermined position in 3D space for lighting the plants.

8. The system of claim 1, wherein each of the left and right panels is adjustable to position the LEDs on the panels at a predetermined position in 3D space for lighting the plants.

9. The system of claim 1, comprising positioning the LEDs for two or more of:
light intensity,
total light over time,
light at a selected time;
light/dark period per day;
light quality (spectrum);
light direction; and
light distribution over the plant.

10. The system of claim 1, comprising lights positioned on the module and panels.

11. The system of claim 10, wherein the lights comprise light emitting diodes (LEDs)

12. The system of claim 1, wherein the lights are selected from a group consisting of: incandescent, fluorescent lights, high-intensity discharge lamps (HID), and light-emitting diodes (LED).

13. The system of claim 1, comprising a plurality of plant trays.

14. The system of claim 13, wherein the plant trays are planar on a surface.

15. The system of claim 13, wherein the plant trays are stacked.

16. A method for providing growth light for a plant, comprising:
providing a central module having hingeable arms to secure the central module to a ceiling; left and right panels extending from the central module, wherein each panel is positioned at a selectable inclination and angle to provide placement of the panels at predetermined position to the plant satisfying predetermined plant light requirements; and a plurality of light emitting diodes positioned on the central module and the left and right panels to provide lighting to the plants; and
angling the hingeable arms and panels to provide a predetermine light to the plant.

17. The method of claim 16, comprising determining plant requirements including a number of hours the plant is exposed to light, how many photons are ‘fed’ to the plants (in μmol/m2/s), combinations of light spectrum wavelengths for each growth phase.

18. The method of claim 16, comprising determining lighting luminaires including units of luminaires and luminaire positioning.

19. The method of claim 16, comprising determining predetermined light uniformity at a target illuminated area.

20. The system of claim 1, comprising optimizing the spacing and height of the fixtures.
